(19) United States
(12) Patent Application Publication
(10) Pub. No.: US 2026/0124889 A1
(43) Pub. Date: May 7, 2026

(54) PICKUP TRUCK BED COVER AND MANUFACTURING METHOD THEREOF

(71) Applicant: SHENZHEN YANGNING AUTO ACCESSORY CO., LTD, SHENZHEN (CN)

(72) Inventor: SHIAWDAR SHAUN YUE, SHENZHEN (CN)

(21) Appl. No.: 19/370,928

(22) Filed: Oct. 28, 2025

(30) Foreign Application Priority Data
Nov. 1, 2024 (CN) 202411554929.9
Nov. 1, 2024 (CN) 202411554938.8
Nov. 1, 2024 (CN) 202422669471.3
May 20, 2025 (CN) 202510648270.1

(51) Int. Cl. B60J 7/16

(52) U.S. Cl. CPC B60J 7/1607

(57) ABSTRACT

A pickup truck bed cover and a manufacturing method thereof are disclosed. The pickup truck bed cover includes a cover body and a support assembly. The cover body is of an integral structure, and the cover body is of a carbon-fiber material structure. The support assembly is arranged inside the cover body and configured to support the cover body.

### CROSS-REFERENCE TO RELATED APPLICATIONS

The present application claims the priority and benefit of Chinese patent application number 2025106482701, titled “Pickup Truck Bed Cover and Manufacturing Method Thereof” and filed on May 20, 2025 with China National Intellectual Property Administration, the entire contents of which are incorporated herein by reference.

The present application claims the priority and benefit of Chinese patent application number 2024226694713, titled “Pickup Truck Bed Cover” and filed on Nov. 1, 2024 with China National Intellectual Property Administration, the entire contents of which are incorporated herein by reference.

The present application claims the priority and benefit of Chinese patent application number 2024115549299, titled “Pickup Truck Bed Cover” and filed on Nov. 1, 2024 with China National Intellectual Property Administration, the entire contents of which are incorporated herein by reference.

The present application claims the priority and benefit of Chinese patent application number 2024115549388, titled “Pickup Truck Bed Cover and Manufacturing Method Thereof” and filed on Nov. 1, 2024 with China National Intellectual Property Administration, the entire contents of which are incorporated herein by reference.

### TECHNICAL FIELD

The present application relates to the technical field of automobile accessories, and more particularly relates to a pickup truck bed cover and a manufacturing method thereof.

### BACKGROUND

The description provided in this section is intended for the mere purpose of providing background information related to the present application but does not necessarily constitute prior art.

A pickup truck is a vehicle that uses a sedan front and cab and has an open truck compartment. It has the features that it has the comfort of a sedan, but also has strong power, and is stronger than a sedan in terms of cargo carrying and adaptability to bad roads. It is an important part of the automobile market. One pickup truck model is a double-row pickup truck. Pickup trucks can be used as special-purpose vehicles, multi-purpose vehicles, official vehicles, business vehicles, and family vehicles for cargo, travel, rental, etc.

A pickup truck is a vehicle with a rear cargo box, and the rear cargo box may be used to load cargo. A pickup truck bed cover may be installed on the rear cargo box to prevent the cargo from being easily affected by the external environment.

However, the current pickup truck bed cover is relatively heavy, which is inconvenient to carry and install.

### SUMMARY

An objective of the present application is to provide a pickup truck bed cover and a manufacturing method thereof so that the pickup truck bed cover has a relatively low weight and is not prone to deformation.

The present application discloses a pickup truck bed cover. The pickup truck bed cover includes a cover body and a support assembly. The cover body is of an integral structure, and the cover body is of a carbon-fiber material structure. The support assembly is arranged inside the cover body and configured to support the cover body.

The present application further discloses a pickup truck bed cover. The pickup truck bed cover includes a cover body, a support assembly and a reinforcement assembly. The cover body is of an integral structure, and the cover body is of a carbon-fiber material structure. The support assembly is of a PMI foam material structure and is arranged inside the cover body and configured to support the cover body. The reinforcement assembly is arranged at the bottom of the cover body and configured to increase a structural strength of the cover body. The reinforcement assembly and the cover body are an integral structure. The reinforcement assembly includes an annular reinforcing rib, two bar-shaped reinforcing ribs, three transverse reinforcing ribs, and four V-shaped reinforcing ribs. The annular reinforcing rib is arranged along edges of the bottom cover. The two bar-shaped reinforcing ribs are arranged within an enclosing range of the annular reinforcing rib. Two ends of each of the two bar-shaped reinforcing ribs are respectively connected to two opposite sides of the annular reinforcing rib. The two bar-shaped reinforcing ribs are arranged in parallel with each other. The three transverse reinforcing ribs are sequentially and equally spaced, the three transverse reinforcing ribs are arranged between the two bar-shaped reinforcing ribs, and the two ends of each of the three transverse reinforcing ribs are respectively connected to the two bar-shaped reinforcing ribs. Two of the four V-shaped reinforcing ribs are arranged in parallel between each of the bar-shaped reinforcing ribs and the side-walls of the adjacent annular reinforcing rib. A bottom of each V-shaped reinforcing rib is connected to the corresponding bar-shaped reinforcing rib, and a top of the V-shaped reinforcing rib is connected to the corresponding adjacent side wall of the annular reinforcing rib.

The present application further discloses a method for manufacturing a pickup truck bed cover, the method including:
pasting carbon-fiber films with a first preset number of layers onto a mold;
placing a support assembly at a preset position on the carbon-fiber film with the first preset number of layers;
pasting carbon-fiber films with a second preset number of layers onto the support assembly; and
separating all the carbon-fiber films and the support assembly from the mold to obtain a pickup truck bed cover.

The beneficial effects of the present application are as follows. Compared with traditional metals and rigid plastics, carbon-fiber materials have a relatively low weight. By adopting a cover body with a carbon-fiber material structure and the cover body being an integral structure in the present embodiment, the overall mass of the cover body is relatively small, facilitating the installation and handling of the cover body. Moreover, considering that the strength of carbon-fiber material is insufficient, a support assembly is additionally provided in the pickup truck bed cover to support the cover body and prevent it from deforming in the present embodiment. Also, since the support assembly is arranged inside the cover body, it is not exposed and cannot be observed by users, making the integral effect of the pickup truck bed cover better, thus improving the aesthetic appearance of the pickup truck bed cover.

In addition, compared with the solution of adding a rigid plastic bottom cover at the bottom of the carbon-fiber top cover to prevent the surface layer carbon-fiber top cover from deforming. The cover body is an integral structure in the present embodiment, regardless of the ambient temperature where the pickup truck bed cover is located, all parts of the cover body expand and contract to the same extent. As a result, there will be no problems such as deformation and detachment caused by different expansion degrees due to inconsistent inner and outer layer materials in the cover body, thus ensuring the stability of the cover body.

### BRIEF DESCRIPTION OF DRAWINGS

The accompanying drawings are used to provide a further understanding of the embodiments according to the present application, and constitute a part of the specification. They are used to illustrate the embodiments according to the present application, and explain the principles of the present application in conjunction with the text description.

Apparently, the drawings in the following description merely represent some embodiments of the present disclosure, and for those having ordinary skill in the art, other drawings may also be obtained based on these drawings without investing creative. In the drawings:

FIG. 1 is a three-dimensional schematic diagram of a pickup truck bed cover according to an embodiment of the present application.

FIG. 2 is a front-view schematic diagram of a cover body according to an embodiment of the present application.

FIG. 3 is a schematic diagram of a pickup truck bed cover having a car wrap according to an embodiment of the present application.

FIG. 4 is a schematic diagram of a cover body combined with a bracket assembly according to an embodiment of the present application.

FIG. 5 is an enlarged schematic diagram based on portion A shown in FIG. 4.

FIG. 6 is a cover body combined with a switch assembly according to an embodiment of the present application.

FIG. 7 is a schematic diagram of a first elastic lock piece according to an embodiment of the present application.

FIG. 8 is an enlarged schematic diagram based on portion B shown in FIG. 4.

FIG. 9 is a schematic diagram of a cover body combined with a reinforcement assembly according to an embodiment of the present application.

FIG. 10 is a schematic diagram of another cover body combined with a reinforcement assembly according to an embodiment of the present application.

FIG. 11 is a schematic diagram of another cover body combined with a reinforcement assembly according to an embodiment of the present application.

FIG. 12 is a schematic diagram of another cover body according to an embodiment of the present application.

FIG. 13 is a schematic diagram of a multilayer structure of a surface cover according to an embodiment of the present application.

FIG. 14 is a schematic diagram of an outermost carbon fiber fabric layer in a surface cover according to an embodiment of the present application.

FIG. 15 is a schematic diagram of a bottom cover according to an embodiment of the present application.

FIG. 16 is a cross-sectional schematic diagram of a pickup truck bed cover combined with a support pad according to an embodiment of the present application.

FIG. 17 is a flowchart of a method of manufacturing a pickup truck bed cover according to an embodiment of the present application.

FIG. 18 is a flowchart of a repair step according to an embodiment of the present application.

### DETAILED DESCRIPTION OF EMBODIMENTS

It should be understood that the terms used herein, the specific structures and functional details disclosed therein are merely representative for describing some specific embodiments, but the present application can be implemented in many alternative forms and should not be construed as being limited to only these embodiments described herein.

As used herein, terms “first”, “second”, or the like are merely used for illustrative purposes, and shall not be construed as indicating relative importance or implicitly indicating the number of technical features specified.

Thus, unless otherwise specified, the features defined by “first” and “second” may explicitly or implicitly include one or more of such features. Terms “multiple”, “a plurality of”, and the like mean two or more.

Terms “comprise”, “comprising”, “includes”, “including”, and any variations thereof are intended to be non-exclusive, and one or more other features, integers, operations, operations, units, components, and/or combinations thereof may be present or be added.

In addition, terms “center” “lateral”, “up”, “down”, “left”, “right”, “vertical”, and “horizontal”, “top”, “bottom”, “inside”, or the like are used to indicate orientational or relative positional relationships based on those illustrated in the drawings. They are merely intended for simplifying the description of the present disclosure, rather than indicating or implying that the device or element referred to must have a particular orientation or be constructed and operate in a particular orientation. Therefore, these terms are not to be construed as restricting the present disclosure.

For the time being, most of the plate bodies of pickup truck bed covers are made of cold steel plates, fiberglass, and aluminum alloy materials to ensure the strength of the bed cover. However, these plate bodies made of metal materials have a high weight and are not convenient to carry and install, especially the one-piece, non-detachable plate body structure. Furthermore, the aesthetics of the surface of the trunk cover needs to be improved. Even if the surface of the trunk cover is painted or filmed, since the trunk cover may be exposed to the external environment, the surface film layer of the trunk cover will be affected over time, resulting in a decrease in the aesthetics of the trunk cover.

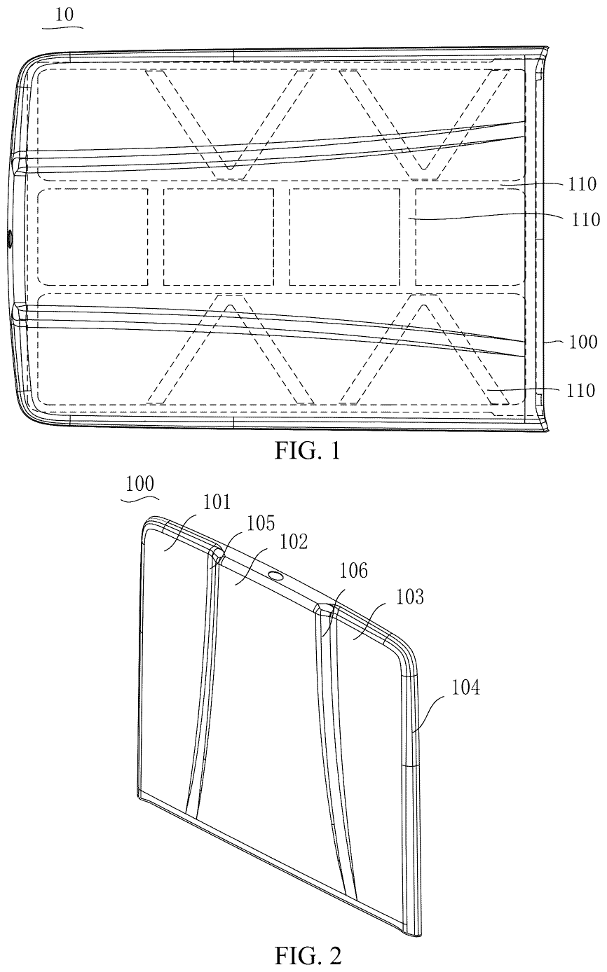

Based on this, embodiments of the present application provide a pickup truck bed cover 10. As shown in FIG. 1, the pickup truck bed cover 10 includes a cover body 100 and a support assembly 110. The cover body 100 is of an integral structure, and the cover body 100 is of a carbon-fiber material structure. The support assembly 110 is arranged inside the cover body 100 and configured to support the cover body 100.

The beneficial effects of the present application are as follows. Compared with traditional metals and rigid plastics, carbon-fiber materials have a relatively low weight. By adopting a cover body 100 with a carbon-fiber material structure and the cover body being an integral structure in the present embodiment, the overall mass of the cover body 100 is relatively small, facilitating the installation and handling of the cover body 100. Moreover, considering that the strength of carbon-fiber material is insufficient, a support assembly 110 is additionally provided in the pickup truck bed cover 10 to support the cover body 100 and prevent it from deforming in the present embodiment. Also, since the support assembly 110 is arranged inside the cover body 100, it is not exposed and cannot be observed by users, making the integral effect of the pickup truck bed cover 10 better, thus improving the aesthetic appearance of the pickup truck bed cover 10.

In addition, compared with the solution of adding a rigid plastic bottom cover at the bottom of the carbon-fiber top cover to prevent the surface layer carbon-fiber top cover from deforming. The cover body 100 is an integral structure in the present embodiment, regardless of the ambient temperature where the pickup truck bed cover 10 is located, all parts of the cover body 100 expand and contract to the same extent. As a result, there will be no problems such as deformation and detachment caused by different expansion degrees due to inconsistent inner and outer layer materials in the cover body 100, thus ensuring the stability of the cover body 100.

It should be noted that “the cover body 100 is of an integral structure, and the cover body 100 is of a carbon-fiber material structure” means that the cover body 100 is basically composed of carbon-fiber material and does not require secondary processing or splicing. This may refer to directly manufacturing the cover body 100 from carbon-fiber material using technologies such as injection molding or 3D printing. It may also refer to forming the cover body 100 by laminating carbon-fiber films layer by layer. After the cover body 100 is formed, it appears as an integral and non-detachable structure to the overall human visual perception, and no splicing marks may be seen on the cover body 100. Among them, when the design of forming the cover body 100 by laminating carbon-fiber films layer by layer is adopted, the cover body 100 is mainly composed of carbon-fiber. However, in the actual manufacturing of the cover body 100, there will be adhesives between the carbon-fiber films for bonding these films. Also, a small amount of glass fibers or tough materials are added between the carbon-fiber films to ensure the strength and stability of the cover body 100. This does not affect the definition of the carbon-fiber material structure. Therefore, it is understandable that the carbon-fiber material structure does not specifically refer to a structure made of 100% pure carbon-fiber materials.

It should be noted that “the support assembly 110 is arranged inside the cover body 100” means that during the manufacturing process of the cover body 100, the support component 110 is embedded inside the cover body 100, so that the support component 110 is not exposed outside the cover body 100. Moreover, arranging the support component 110 inside the cover body 100 does not affect the definition of the cover body 100 as an integral structure. This is because the support component 110 is added during the manufacturing process of the cover body 100, similar to secondary injection molding, and the support component 110 and the cover body 100 are not able to be separated. Eventually, the cover body 100 still appears as an integral structure as a whole, so it does not affect the definition of the cover body 100 as an integral structure.

The support assembly is of a PMI (Polymethacrylimide) foam material structure in the present embodiment. Since the cover body 100 needs to go through high-temperature and high-pressure processes during the molding process, and the support component 110 has been filled inside the cover body 100 during these processes, the support component 110 has to experience the high-temperature and high-pressure environment just like the cover body 100. If the support component 110 undergoes significant expansion or contraction under high-temperature and high-pressure conditions, it will cause the cover body 100 to deform. Considering this, the support component 110 with a PMI foam material structure is adopted in the present embodiment. Due to the characteristics of PMI foam material, such as high-temperature resistance and high-pressure resistance, significant deformation of the support component 110 under high-temperature and high-pressure conditions is avoided. Therefore, the support component 110 with a PMI foam material structure will not affect the shape of the cover body 100 and its supporting effect on the cover body 100 after the cover body 100 is molded.

As shown in FIG. 2, in one or more embodiments, the surface cover 100 is not a planar structure, and specifically includes a first top surface part 101, a second top surface part 102, a third top surface part 103, and an edge part 104. Along the width direction of the cover body, the first top surface part 101, the second top surface part 102, and the third top surface part 103 are distributed in sequence. The second top surface part 102 has a higher height than the first top surface part 101 and the third top surface part 103 on the front side of the cover body 100; the first top surface part 101 and the third top surface part 103 both protrude from the second top surface part 102 on the back side of the cover body 100, that is, the second top surface part 102 is retracted relative to the first top surface part 101 and the third top surface part 103.

A first stepped surface 105 is formed between the second top surface part 102 and the first top surface part 101, and a second stepped surface 106 is formed between the second top surface part 102 and the third top surface part 103. The edge part 104 is arranged at the edge of the cover body 100 and is arranged surrounding the first top surface part 101, the second top surface part 102, and the third top surface part 103.

After the pickup truck bed cover 10 is installed, the rear end of the pickup truck bed cover 10 is rotationally connected to a vehicle body, and the front end of the pickup truck bed cover 10 may rotate around the vehicle body to achieve the opening and closing of the pickup truck bed cover 10.

Furthermore, the two sides of the second top surface part 102 are arc-shaped. From the front end to the rear end of the pickup truck bed cover 10, that is to say, the length direction of the pickup truck bed cover 10, the width of the second top surface part 102 gradually increases. Furthermore, the top surface of the second top surface part 102 is also arc-shaped. From the front end to the rear end of the pickup truck bed cover 10, the height of the second top surface part 102 gradually decreases until it is at the same height as the first top surface part 101 and the third top surface part 103.

In one or more embodiments, the surfaces of the second top surface part 102 and the edge part 104 have carbon-fiber textures. The surfaces of the first top surface part 101 and the third top surface part 103 are black. That is, the top highest position and edge positions of the cover body 100 have carbon fiber textures. The carbon fiber textures may be diamond textures, 3K textures, UD textures, plain textures, twill textures, etc. The two sides of the top and the two step surfaces of the cover body 100 are painted black to further highlight the carbon fiber patterns.

In one or more embodiments, the outer surfaces of the first top surface part 101, the second top surface part 102, the third top surface part 103, and the edge part 104 have carbon-fiber patterns, while the first stepped surface 105 and the second stepped surface 106 are painted black. Of course, other combinations may also be adopted.

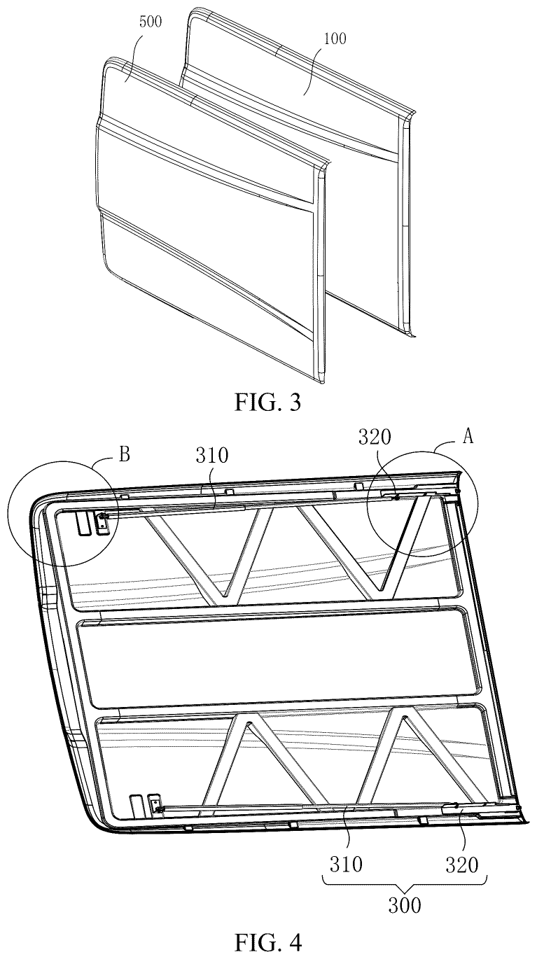

As shown in FIG. 3, in one or more embodiments, the pickup truck bed cover includes a car wrap 500 that wraps around an outer side of the cover body 100, the car wrap 500 being made of a polypropylene material. A range of the thickness of the car wrap 500 is from 0.5 mm to 2 mm. The car wrap 500 has elasticity and may play the roles of anti-impact and anti-ultraviolet, further improving the service life of the pickup truck bed cover 10.

As shown in FIG. 4, in one or more embodiments, the pickup truck bed cover 10 includes a bracket assembly 300. The bracket assembly 300 is arranged at the bottom of the cover body 100 and is configured to connect the cover body 100 to a vehicle body. The cover body 100 includes a front end, a rear end, and two sides; wherein the rear end of the cover body 100 is rotatably connected to the vehicle body, wherein the front end of the cover body 100 is an opening and closing end of the pickup truck bed cover 10.

Specifically, the bracket assembly 300 includes two air springs 310 and two connectors 320. The two air springs 310 and the two connectors 320 are both located on the back of the cover body 100. An air spring 310 and a connector 320 are disposed on each of both sides of the cover body 100. The connector 320 includes a first fixing portion 321 and a second fixing portion 322 that are arranged in parallel. The first fixing portion 321 is disposed on the side of the second fixing portion 322 facing away from the rear end of the cover body 100. One end of the air spring 310 is connected to the area near the front end of the cover body 100. The other end of the air spring 310 is connected to the first fixing portion 321. The second fixing portion 322 is connected to the vehicle body. When the pickup truck bed cover 10 needs to be opened, the two air springs 310 are extended to support the front end of the cover body 100 simultaneously.

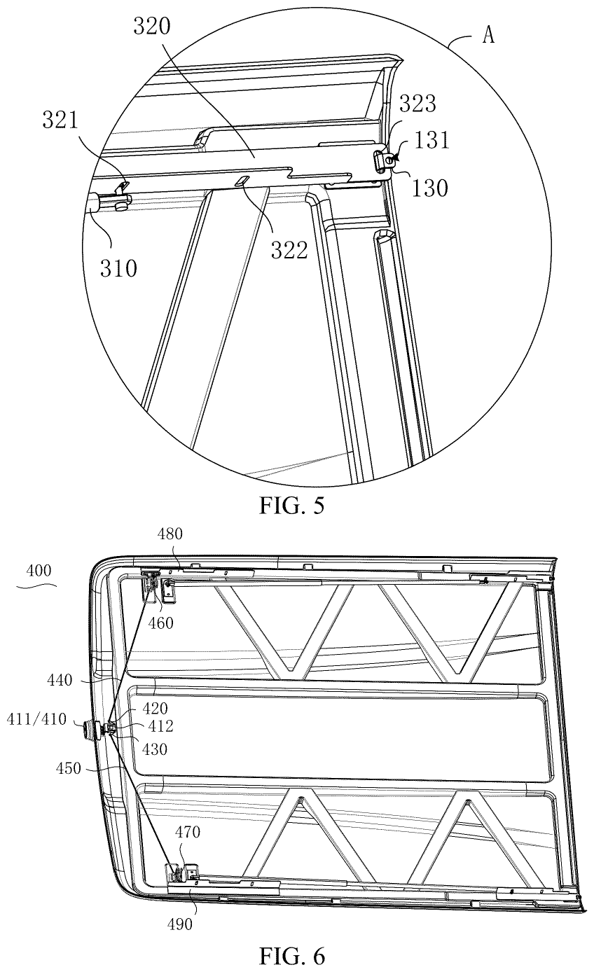

As shown in FIG. 5, the rear end of the cover body 100 has at least two C-shaped inserts 130. One end of each C-shaped insert 130 is connected to the cover body 100, specifically fixed to the back of the cover body 100. The other end of the C-shaped insert 130 includes a socket 131, and the C-shaped insert 130 is connected to the vehicle body by means of a collar passing through the socket 131. The collar is annular, and the collar passes through the socket 131 in the C-shaped insert 130 and a corresponding connecting hole in the vehicle body to connect the rear end of the pickup truck bed cover 10, so that the C-shaped insert 130 and the pickup truck bed cover 10 may rotate around the vehicle body.

It should be noted that the C-shaped insert 130 is not interpreted as the cross section of the insert being only C-shaped, but is just a similar shape representation, and the insert may also be an L-shaped or U-shaped structure in other embodiments.

The connector 320 further includes a third fixing portion 323, which is arranged on the side of the second fixing portion 322 facing away from the first fixing portion 321. The third fixing portion 323 is sleeved on the C-shaped insert 130, and the third fixing portion 323 is an elliptic through hole, whose long axis is greater than the width of the C-shaped insert 130, and whose short axis is less than the width of the C-shaped insert 130.

When the pickup truck bed cover 10 needs to be opened, the air springs 310 are extended. Since the first fixing portion 321 and the second fixing portion 322 are both vertical elliptical and perpendicular to the third fixing portion 323, the screw connecting the air spring 310 moves in the first fixing portion 321, and the screw connecting the vehicle body moves in the second fixing portion 322, thereby enabling the C-shaped insert 130 and the cover body 100 to rotate.

In addition, the pickup truck bed cover 10 in the embodiment of the present application is easy to open and close. As shown in FIG. 6, the pickup truck bed cover 10 further includes a switch assembly 400. The switch assembly 400 includes an elastic button piece 410, a first paddle 420, a second paddle 430, a first traction wire 440, a second traction wire 450, a first elastic lock piece 460, a second elastic lock piece 470, a first fixing plate 480, and a second fixing plate 490. The elastic button piece 410 is connected to the front end of the cover body 100. The first paddle 420, the second paddle 430, the first traction wire 440, the second traction wire 450, the first elastic lock piece 460, the second elastic lock piece 470, the first fixing plate 480, and the second fixing plate 490 are arranged on the back surface of the cover body 100. The first elastic lock piece 460 and the second elastic lock piece 470 are each connected to the cover body 100. The first fixing plate 480 and the second fixing plate 490 are each connected to the vehicle body. The first elastic lock piece 460 and the second elastic lock piece 470 are respectively located on both sides of the cover body 100. The first fixing plate 480 and the second fixing plate 490 are respectively located on both sides of the cover body 100. That is, each side of the cover body 100 has an elastic lock piece and a fixing plate.

The elastic button piece 410 is inserted through the cover body 100 and the control end 411 of the elastic button piece 410 protrudes from the front end of the cover body 100. The connecting end 412 of the elastic button piece 410 is connected to both the first paddle 420 and the second paddle 430. The first paddle 420 and the second paddle 430 may be two separate structures or an integrated structure.

In one or more embodiments, the first paddle 420 and the second paddle 430 may be two separate structures, which do not affect each other and are driven independently. Furthermore, the first paddle 420 is further connected to one end of the first traction wire 440, and the other end of the first traction wire 440 is drivingly connected to the first elastic lock piece 460. The first elastic lock piece 460 is locked up in cooperation with the first fixing plate 480.

Correspondingly, the second paddle 430 is further connected to one end of the second traction wire 450, and the other end of the second traction wire 450 is drivingly connected to the second elastic lock piece 470. The second elastic lock piece 470 is locked up in cooperation with the second fixing plate 490.

When the control end 411 of the elastic button piece 410 is pressed, the elastic button piece 410 controls the first traction wire 440 and the second traction wire 450 to retract through the first paddle 420 and the second paddle 430, respectively, so that the first elastic lock piece 460 is separated from the first fixing plate 480, and the second elastic lock piece 470 is separated from the second fixing plate 490, and so the pickup truck bed cover 10 is opened.

When the pickup truck bed cover 10 is closed, the first elastic lock piece 460 is locked with the first fixing plate 480, the second elastic lock piece 470 is locked with the second fixing plate 490, the first traction wire 440 and the second traction wire 450 are extended, and the first paddle 420, the second paddle 430, and the elastic button piece 410 are reset.

It should be noted that the two paddles, as well as the traction wires, elastic locking units, and fixing plates on both sides of the cover body 100 are symmetrically arranged, so that during the opening and closing process of the pickup truck bed cover 10, both sides keep moving simultaneously and both sides are evenly stressed, so that the pickup truck bed cover 10 opens and closes stably.

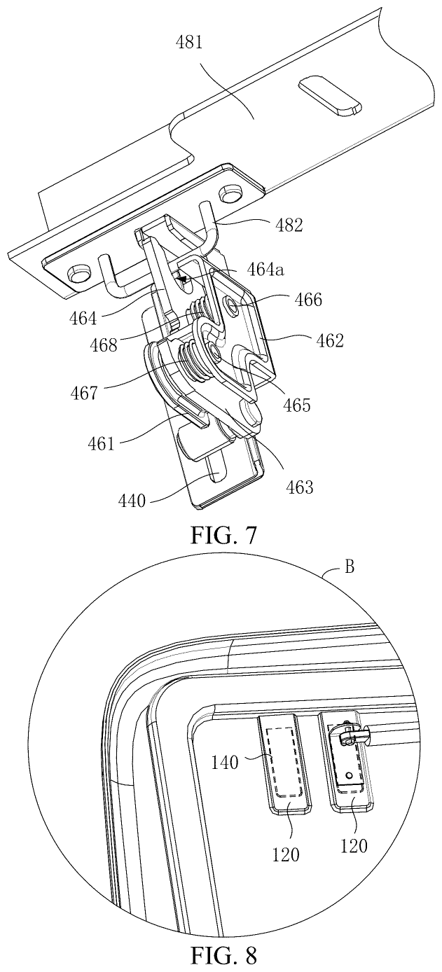

As shown in FIG. 7, taking the first elastic lock piece 460 as an example, the first elastic lock piece 460 includes a first mounting seat 461, a second mounting seat 462, a first swing arm 463, a second swing arm 464, a first connecting column 465, a second connecting column 466, a first torsion spring 467, and a second torsion spring 468. The first mounting seat 461 is connected to the cover body 100. The second mounting seat 462 and the first mounting seat 461 are arranged to be aligned and combined with each other. A transmission space is formed between the second mounting seat 462 and the first mounting seat 461. The first connecting column 465 and the second connecting column 466 are arranged in parallel in the transmission space. The two ends of the first connecting column 465 are connected to the second mounting seat 462 and the first mounting seat 461 respectively. The two ends of the second connecting column 466 are connected to the second mounting seat 462 and the first mounting seat 461 respectively.

The transmission end of the first swing arm 463, the second swing arm 464, the first torsion spring 467, and the second torsion spring 468 are arranged in the transmission space. The main body of the first torsion spring 467 is sleeved on the first connecting column 465. A torsion arm of the first torsion spring 467 is connected to the first swing arm 463. The main body of the second torsion spring 468 is sleeved on the second connecting column 466. The torsion arm of the second torsion spring 468 is connected to the second swing arm 464. The first traction wire 440 is connected to the connecting end of the first swing arm 463. The transmission end of the first swing arm 463 is drivingly connected to one end of the second swing arm 464. The other end of the second swing arm 464 includes a lock hook 464a. The first fixing plate 480 includes a fixing piece 481 and a U-shaped lock rod 482. The fixing piece 481 is connected to the vehicle body. Both ends of the U-shaped lock rod 482 are connected to the fixing piece 481.

When the first traction wire 440 is retracted, the tightening force of the first traction wire 440 is transmitted to the second swing arm 464 through the first swing arm 463. The lock hook 464a of the second swing arm 464 is thus lifted, and the U-shaped lock rod 482 is disengaged from the lock hook 464a of the second swing arm 464.

When the first traction wire 440 is extended, the first swing arm 463 is reset under the action of the first torsion spring 467, the second swing arm 464 is reset under the action of the second torsion spring 468, and the lock hook 464a of the second swing arm 464 sinks.

As shown in FIG. 8, two protrusions 122 are disposed on each side of the cover body 100. An inner panel 140 is disposed provided inside the protrusions 122. One end of the air spring 310 is connected to the inner panel 140 below the corresponding protrusion 122. The first mounting seat 461 is connected to the inner panel 140 below the corresponding protrusion 122. This arrangement may avoid damaging the cover body 100 when drilling holes and making connections at the bottom of the cover body 100, avoid the problem of cracking the cover body 100 due to a small connection area, and also improve the aesthetics of the bottom of the cover body 100.

The inner panel 140 is placed inside the cover body 100 through an embedding process during the manufacturing process of the cover body 100. And due to the thickness of the inner panel 140 itself, a local position at the bottom of the cover body 100 protrudes outward to form the protrusions 122.

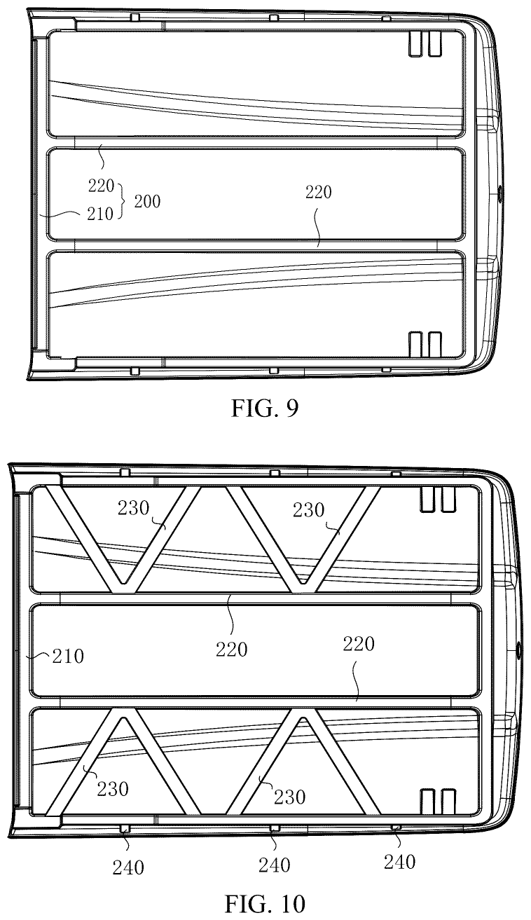

As shown in FIG. 9, in order to improve the strength of the cover body 100, the pickup truck bed cover 10 further includes a reinforcement assembly 200. The reinforcement assembly 200 is arranged at the bottom of the cover body 100. The reinforcement assembly 200 and the cover body 100 are of an integral structure, and the reinforcement assembly 200 is of a carbon-fiber material structure. It may also be understood that the reinforcement assembly 200 is part of the structure of the cover body 100.

The reinforcement assembly 200 includes an annular reinforcing rib 210 and at least two bar-shaped reinforcing ribs 220. The annular reinforcing rib 210 is annular and arranged along the edges of the cover body 100. The bar-shaped reinforcing ribs 220 are arranged within the enclosing range of the annular reinforcing rib 210. Both ends of each bar-shaped reinforcing rib 220 are respectively connected to the opposite sides of the annular reinforcing rib 210. The at least two bar-shaped reinforcing ribs 220 are arranged in parallel with each other, and the length direction of each bar-shaped reinforcing rib 220 is identical with the length direction of the cover body 100.

As an optional implementation, since the cover body 100 includes a first top surface part 101, a second top surface part 102, and a third top surface part 103. The reinforcement assembly 200 only has an annular reinforcing rib 210 and two parallel bar-shaped reinforcing ribs 220 in the present embodiment. The orthographic projections of the two bar-shaped reinforcing ribs 220 are within the range of the orthographic projection of the second top surface part 102.

The second top surface part 102 of the cover body 100 is the highest and is easily hit. The second top surface part 102 is also located in the middle of the cover body 100 and is more significantly affected by gravity. Therefore, the bar-shaped reinforcing ribs 220 are disposed below the second top surface part 102 to strengthen the structural strength of the middle area of the cover body 100. The annular reinforcing rib 210 strengthens the structural strength of the edge region 116 of the cover body 1000. Combined, the strength of the entire cover body 100 may be effectively enhanced.

Of course, in other embodiments, the number of bar-shaped reinforcing ribs 220 may not be two, and the number may be determined depending on actual conditions.

Further, as shown in FIG. 10, the reinforcement assembly 200 further includes a plurality of V-shaped reinforcing ribs 230. At least two V-shaped reinforcing ribs 230 are disposed between the bar-shaped reinforcing rib 220 and the adjacent side wall of the annular reinforcing rib 210. The bottom of the V-shaped reinforcing rib 230 is connected to the corresponding bar-shaped reinforcing rib 220. The top of the V-shaped reinforcing rib 230 is connected to the side wall of the corresponding annular reinforcing rib 210. It should be noted that the bottom of the V-shaped reinforcing rib 230 refers to the end where the two sides of the V-shaped reinforcing rib 230 intersect, and the top of the V-shaped reinforcing rib 230 refers to the end where the two sides of the V-shaped reinforcing rib 230 are spaced away from each other.

Since the air spring 310 and its connecting parts are disposed on each of both sides of the cover body 100, and part of the structures in the switch assembly 400 is also disposed there, the structural strength of the two sides of the cover body 100 is enhanced by providing V-shaped reinforcing ribs 230 on both sides of the back of the bottom cover 120. Furthermore, the top and bottom ends of the V-shaped reinforcing rib 230 are respectively connected to the annular reinforcing rib 210 and the bar-shaped reinforcing rib 220. The annular reinforcing rib 210 and the bar-shaped reinforcing ribs 220 are thus combined by the V-shaped reinforcing ribs 230, so that the reinforcement assembly 200 forms a whole, which can effectively strengthen the strength of the surface cover 110 and the bottom cover 120. The V-shaped reinforcing rib 230 may also be replaced with an X-shaped or other-shaped reinforcing rib in other embodiments.

As a specific example, the reinforcement assembly 200 has only an annular reinforcing rib 210, two parallel bar-shaped reinforcing ribs 220, and four V-shaped reinforcing ribs 230. The orthographic projections of the two bar-shaped reinforcing ribs 220 are located within the range of the orthographic projection of the second top surface part 102, and the two bar-shaped reinforcing ribs 220 are respectively arranged to be in proximity to the adjacent step surfaces. The two reinforcing ribs are arranged in parallel between one bar-shaped reinforcing rib 220 and the side wall of the adjacent annular reinforcing rib 210. The other two reinforcing ribs are arranged in parallel between another bar-shaped reinforcing rib 220 and the side wall of the adjacent annular reinforcing rib 210.

Of course, in other embodiments, the number of V-shaped reinforcing ribs 230 on each side of the cover body 100 may not be two, and the selection may be made depending on the actual situation.

Furthermore, the reinforcement assembly 200 further includes a plurality of edge reinforcing ribs 240. The edge reinforcing ribs 240 are disposed between the annular reinforcing rib 210 and the edges of the cover body 100. One end of each edge reinforcing rib 240 is connected to the outer side of the annular reinforcing rib 210. The other end of the edge reinforcing rib 240 is connected to the corresponding edge of the cover body 100. Through the above design, the structural strength of the edge region of the cover body 100 may be further improved, and the edge region of the cover body 100 may be prevented from bending or breaking.

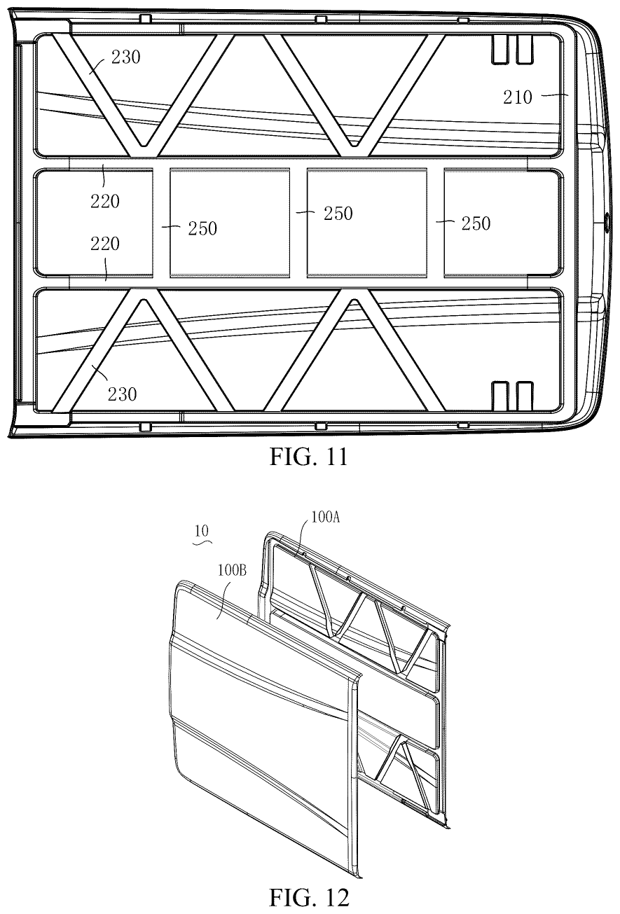

As shown in FIG. 11, in one or more embodiments, the reinforcement assembly 200 further includes at least two transverse reinforcing ribs 250, the at least two transverse reinforcing ribs 250 are arranged in parallel; the at least two transverse reinforcing ribs 250 are arranged between the two bar-shaped reinforcing ribs 220, and the two ends of each of the transverse reinforcing ribs 250 are respectively connected to the two bar-shaped reinforcing ribs. Since the cover body 100 has a relatively large area and a small thickness, when handling and installing the cover body 100, if force is only applied to a local part of the cover body 100, it is likely to cause the cover body 100 to be distorted and deformed. In severe cases, it may lead to the cracking of the cover body 100. Based on this, a transverse reinforcing rib 250 is added in the middle area of the cover body 100 to further enhance the structural strength of the middle area of the cover body 100 in the present embodiment, improve the torsional resistance of the pickup truck bed cover 10, and ensure the stability of the pickup truck bed cover 10.

As a specific example, the reinforcement assembly 200 has three transverse reinforcing ribs 250. The transverse reinforcing rib 250 has a strip-shaped structure, and the three transverse reinforcing ribs 250 are respectively arranged perpendicular to the bar-shaped reinforcing ribs 220 on both sides.

In other embodiments, the reinforcement assembly 200 may also have only two or more than four transverse reinforcing ribs 250. Moreover, the transverse reinforcing ribs 250 may also be arranged obliquely to the bar-shaped reinforcing ribs 220. Furthermore, the transverse reinforcing ribs 250 may adopt other shape designs.

As shown in FIG. 12, in one or more embodiments, the cover body 100 includes a bottom cover 100A and a surface cover 100B. The surface cover 100B is arranged to be in full contact with the bottom cover 100A. The bottom cover 100A is made of a hard plastic. The main body of the surface cover 100B is made of carbon fiber material. It may be understood that most or even all of the surface cover 100B is made of carbon fiber material.

In this embodiment of the present application, the cover body 100 of the pickup truck bed cover 10 is arranged as a double-layer structure consisting of a bottom cover 100A and a surface cover 100B. The inner bottom cover 100A is made of hard plastic to ensure the shape and strength of the cover body 100. The main body of the outer surface cover 100B is made of carbon fiber material. Since the carbon fiber material is light, the overall mass of the cover body 100 is relatively small, which makes it convenient for installing and carrying the cover body 100.

In addition, the structure made of carbon fiber material has a relatively stable pattern and color on the surface, which are resistant to high and low temperatures, and have a long service life, thereby ensuring the aesthetics of the surface of the car wrap for a long time.

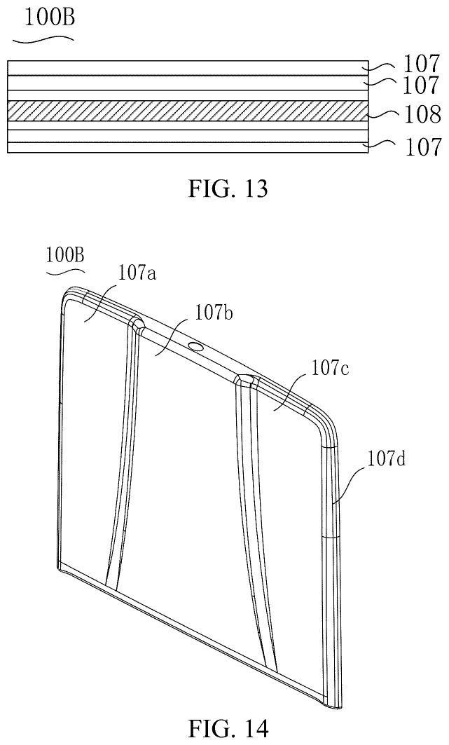

As shown in FIG. 13, in the embodiments of the present application, the surface cover 100B includes a plurality of carbon fiber fabric layers 107. The plurality of carbon fiber fabric layers 107 are stacked to constitute the main body of the surface cover 100B.

Compared with the solution of obtaining the surface cover 100B from directly injecting the carbon fiber material, the surface cover 100B formed by laminating multiple layers of carbon fiber fabric is simpler to manufacture, faster in production speed and lower in cost.

Each carbon fiber fabric layer 107 may be a carbon fiber fabric piece having a glue, so that the carbon fiber fabric can be directly bonded together. Of course, the carbon fiber fabric layer 107 may also be a carbon fiber fabric without glue. When bonding the carbon fiber, an additional layer of impregnated glue needs to be applied to adhere the upper and lower layers of carbon fiber fabric to each other.

In particular, the surface cover 100B includes a number of 5-8 carbon fiber fabric layers 107. That is, the main body of the surface cover 100B is composed of 5-8 layers of carbon fiber fabric stacked together. It is found through experiments that such an arrangement can ensure the hardness of the surface cover 100B itself to facilitate the alignment and bonding with the bottom cover 100A, and can also cover the defects at the junctions of the carbon fiber fabric.

In one or more embodiments, the surface shape of the surface cover 100B is the same as that of the cover body 100, both including a first top surface part 101, a second top surface part 102, a third top surface part 103, and an edge part 104.

As shown in FIG. 14, the outermost carbon fiber fabric layer 107 of the surface cover 100B includes a first carbon fiber piece 107a, a second carbon fiber piece 107b, and a third carbon fiber piece 107c. The first carbon fiber piece 107a is at least arranged in the first top surface part 101. The second carbon fiber piece 107b is at least arranged in the second top surface part 102. The third carbon fiber piece 107c is arranged at least in the third top surface part 103. The joint of the first carbon fiber piece 107a and the second carbon fiber piece 107b is located on the first step surface 105. The joint of the third carbon fiber piece 107c and the second carbon fiber piece 107b is located on the second step surface 106. The first step surface 105 and the second step surface 106 may subjected to concealment treatment. That is, the position where the first carbon fiber piece 107a and the second carbon fiber piece 107b are spliced is subjected to blackening treatment. The position where the third carbon fiber piece 107c and the second carbon fiber piece 107b are spliced is subjected to blackening treatment.

The first top surface part 101, the second top surface part 102, and the third top surface part 103 are located at the top of the surface cover 100B. After the pickup truck bed cover 10 is installed, the user will only notice the top of the surface cover 100B. The first top surface part 101, the second top surface part 102, and the third top surface part 103 are each made of a complete carbon fiber fabric piece, and there are no splicing marks on the first top surface part 101, the second top surface part 102, and the third top surface part 103, so that the first top surface part 101, the second top surface part 102, and the third top surface part 103 have good aesthetics.

Since the first step surface 105 and the second step surface 106 have a relatively small area and are inclined interfaces, the joint of the carbon fiber fabric pieces is not easily observed at this position, and it is not easy to affect the overall aesthetics of the surface cover 100B.

In particular, in the embodiment of the present application, a concealing treatment is further performed on the first step surface 105 and the second step surface 106, so that it will not be observed by the user, making the entire surface of the surface cover 100B appear as a whole.

The concealment treatment may be a blackening treatment, that is, brushing black paint or a black layer on the joint. The concealment treatment may also be a patterning treatment, that is, applying a patterned coating or pasting a drawing on the joint, or drawing a pattern on the joint.

Of course, other concealing methods may also be used, which are not to be enumerated here in detail.

It should be noted that it is not that the edges of the two carbon fiber fabric pieces are butted at the joint, but that the edges of the two carbon fiber fabric pieces overlap each other to prevent the different carbon fiber fabric pieces of the same layer from falling off. However, such a design will cause a slight height difference at the edge of the same layer of carbon fiber fabric piece, but the concealer design above can perfectly hide this problem.

In addition, the outermost carbon fiber fabric layer 107 further includes a fourth carbon fiber piece 107d. The fourth carbon fiber piece 107d is at least arranged in the edge part 104. The seam between the fourth carbon fiber piece 107d and the first carbon fiber piece 107a is arranged at the corner portion between the edge part 104 and the first top surface part 101. The seam between the fourth carbon fiber piece 107d and the second carbon fiber piece 107b is arranged at the corner portion between the edge part 104 and the second top surface part 102. The seam between the fourth carbon fiber piece 107d and the third carbon fiber piece 107c is arranged at the corner portion between the edge part 104 and the third top surface part 103.

Since the top and edges of the surface cover 100B are not located on the same plane, different carbon fiber fabric pieces may be used for the edge part 104 and the top surface region, which can avoid wrinkles at the corners.

Furthermore, in the embodiment of the present application, the seam between the carbon fiber fabric piece of the edge part 104 and the carbon fiber fabric piece of the top surface region is disposed at the corner area (intersection at the rounded corner) between the edge part 104 and the top surface region. Since the corner area is relatively small and users may not notice this position easily, the seam of the corner area is not easy to be observed and will not affect the overall aesthetics of the pickup truck bed cover 10.

In the embodiment of the present application, after the surface cover 100B is laid with carbon fiber fabric, it needs to go through the operations of grinding, repairing, polishing, painting, etc., so that the surface gloss of the surface cover 100B is higher and the appearance is better.

Furthermore, in a relatively dark environment, the first step surface 105, the second step surface 106 and the corner portions will appear black, so that it is not easy to observe the joints. In a relatively bright environment, on the contrary, the first step surface 105, the second step surface 106, and the corner portions will reflect light, so that it is also not easy to observe the joints.

As a specific example, the surfaces of the second carbon fiber piece 107b and the fourth carbon fiber piece 107d have carbon fiber textures. The surfaces of the first carbon fiber piece 111a and the third carbon fiber piece 111c are black.

As another embodiment, the surface cover 100B includes a number of 1-3 glass fiber layers 108 in addition to 5-8 carbon fiber fabric layers 107. The glass fiber layers 108 are each arranged between the corresponding adjacent carbon fiber fabric layers 107. That is, a glass fiber layer 108 is arranged between two carbon fiber fabric layers 107.

By arranging the glass fiber layer 108 between the carbon fiber fabric layers 107, in addition to further improving the structural strength of the surface cover 100B, the heat resistance of the surface cover 100B can also be improved.

Each glass fiber layer 108 is composed of a plurality of glass fiber strips, which can be distributed on the top, edges or other local areas of the surface cover 100B, or distributed in the entire area of the surface cover 100B.

As a specific example, the surface cover 100B is composed of six carbon fiber fabric layers 107 and one glass fiber layer 108. The glass fiber layer 108 is arranged between the third carbon fiber fabric layer 107c and the fourth carbon fiber fabric layer 107d.

In other examples, the number and positions of the carbon fiber fabric layers 107 and the glass fiber layers 108 may also be combined in other ways, which are not to be enumerated herein.

In particular, the bottom cover 100A is made of ABS material. ABS material has high strength, good toughness and light weight. After being combined with the surface cover 100B mainly made of carbon fiber material, it plays a good complementary role and further highlights the light weight of the cover body 100.

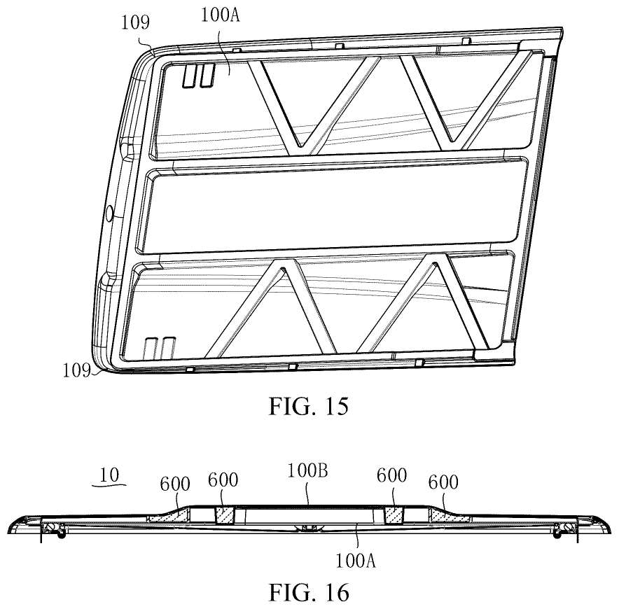

As shown in FIG. 15, a cutout 109 may be defined at the corner of the bottom cover 100A so that after the bottom cover 100A contracts, the bottom cover 100A portion at the cutout 109 provides a contraction margin and an expansion margin, and so when the bottom cover 100A contracts and expands, it is avoided to pull or squeeze the surface cover 100B, causing the adhesive material between the bottom cover 100A and the surface cover 100B to loosen.

In the embodiment of the present application, the pickup truck bed cover 10 further includes a reinforcement assembly 200. The reinforcement assembly 200 is arranged on the side of the bottom cover 100A facing away from the surface cover 100B. The reinforcement assembly 200 may be integrally formed with the bottom cover 100A to form an integrated structure, and it is a structure that is retained when the bottom cover 100A is formed.

As shown in FIG. 16, The interior of the reinforcement assembly 200 is hollow, the present application also fills the reinforcement assembly 200 with a support pad 600, and the support pad 600 abuts against the surface cover 100B to support the surface cover 100B.

In particular, the support pad 600 is made of pearl cotton material. Since the pearl cotton material is relatively light, it can avoid adding weight to the pickup truck compartment 10. Furthermore, the pearl cotton is elastic, which can provide a good buffering effect for the surface cover 100B, and the bottom cover 100A can be adaptively deformed during thermal expansion and contraction to prevent squeezing the bottom cover 100A.

The support pad 600 can be divided into multiple independent parts, which are installed in different reinforcing ribs or different positions of the reinforcing ribs. The support pad 600 may also be a whole, which is disposed in the corresponding reinforcing ribs. The specific design may be based on the actual situation and is not limited here.

Of course, in other embodiments, the support pad 600 may also be made of other lightweight materials, such as sponge, foam, etc.

Of course, the reinforcement assembly 200 has been described previously and will not be elaborated here.

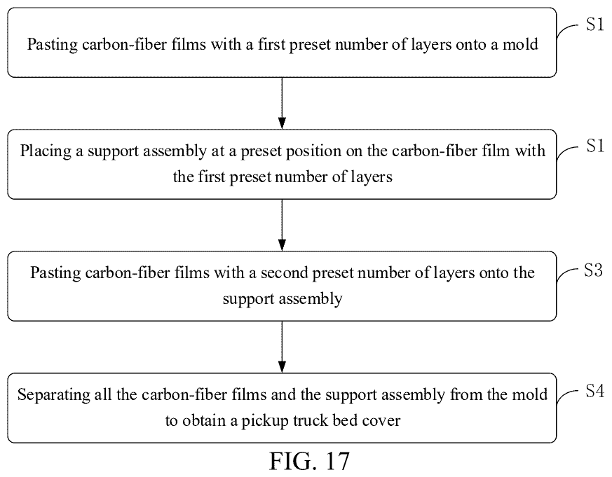

As shown in FIG. 17, embodiments of the present application further disclose a method for manufacturing a pickup truck bed cover, which is used to manufacture the pickup truck bed cover 10 as described above, including the following operations:
S1: pasting carbon-fiber films with a first preset number of layers onto a mold;
S2: placing a support assembly at a preset position on the carbon-fiber film with the first preset number of layers;
S3: pasting carbon-fiber films with a second preset number of layers onto the support assembly;
S4: separating all the carbon-fiber films and the support assembly from the mold to obtain a pickup truck bed cover.

Specifically, in operation S1, the carbon-fiber films are directly pasted onto the mold of the pickup truck bed cover, so that the pasted carbon-fiber films forms the bottom shape of the cover body. And the carbon-fiber films will sink in the groove area of the mold to form the reinforcing component at the bottom of the pickup truck bed cover. Here, the first preset number of layers is 3layers to 6 layers. It should be noted that each layer of the carbon-fiber film may be composed of multiple independent carbon-fiber film blocks. Different carbon-fiber film blocks are pasted in different areas of the mold, ensuring that there are no significant wrinkles between the pasted carbon-fiber films.

In operation S2, the preset position is specifically the position where the reinforcement assembly is located, that is, the position where the carbon-fiber film sinks. The support assembly may adopt multiple strip-shaped PMI foaming material structures. By placing the PMI foaming material structures at the corresponding sinking positions on carbon-fiber films, the overall structural strength of the pickup truck bed cover is enhanced, and carbon-fiber films on the reinforcing component and the top of the cover body are prevented from sagging. At the same time, an inner panel plate may also be placed on the carbon-fiber film for pre-embedding treatment.

In operation S3, the second preset number of layers is 3 layers to 6 layers. The carbon-fiber films of the upper layer covers the carbon-fiber films of the lower layer and the support assembly. Moreover, the carbon-fiber film in step S3 may also be composed of multiple independent carbon-fiber film blocks. Different carbon-fiber film blocks are pasted in different areas of the mold.

In operation S1 and operation S3, in order to improve the structural strength of the pickup truck bed cover, glass fiber or other ductile materials may be added between the carbon-fiber films.

In operation S4, the mold is placed in a high-temperature environment for treatment, so that all the carbon-fiber films are fused into an integral structure. After cooling, a cover body with a support component inside is obtained, that is, the pickup truck bed cover.

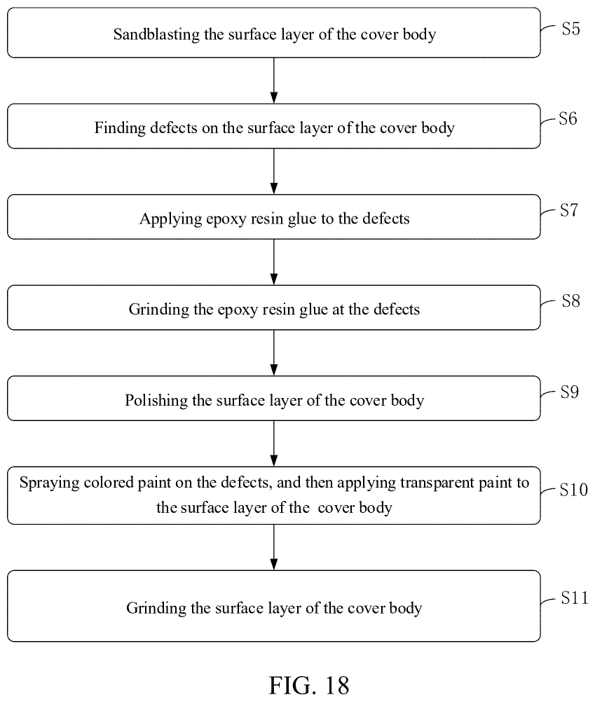

In addition, as shown in FIG. 18, the manufacturing method further includes a repairing operation, and the repairing operation includes:
S5: sandblasting the surface layer of the cover body;
S6: finding defects on the surface layer of the cover body;
S7: applying epoxy resin glue to the defects;
S8: grinding the epoxy resin glue at the defects;
S9: polishing the surface layer of the cover body;
S10: spraying colored paint on the defects, and then applying transparent paint to the surface layer of the cover body;
S11: grinding the surface layer of the cover body.

Through the above-mentioned repairing design, the outer surface of the pickup truck bed cover has no flaws, has good gloss, and the overall aesthetics are further improved.

It should be noted that the limitations of the various operations involved in this solution are not to be interpreted to limit the order of the operations, under the premise of not affecting the implementation of the specific solution. The operations written earlier can be executed first, or later, or even at the same time with the operations written later. The solutions of different embodiments may be combined and applied if no conflict exists. As long as this solution can be implemented, it should be regarded as falling in the scope of protection of the present application.

The foregoing is a further detailed description of the present application with reference to some specific optional implementations, but it cannot be determined that the specific implementation of the present application is limited to these implementations. For those having ordinary skill in the technical field to which the present application pertains, several deductions or substitutions may be made without departing from the concept of the present application, and all these deductions or substitutions should be regarded as falling in the scope of protection of the present application.

What is claimed is:

1. A pickup truck bed cover, comprising:
a cover body, the cover body is of an integral structure, and the cover body is of a carbon-fiber material structure; and
a support assembly, arranged inside the cover body and configured to support the cover body.

2. The pickup truck bed cover according to claim 1, wherein the support assembly is of a PMI foam material structure.

3. The pickup truck bed cover according to claim 2, wherein the pickup truck bed cover comprises a reinforcement assembly that is arranged at the bottom of the cover body and is configured to increase a structural strength of the cover body.

4. The pickup truck bed cover according to claim 3, wherein the reinforcement assembly and the cover body are of an integral structure, and the reinforcement assembly is of a carbon-fiber material structure.

5. The pickup truck bed cover according to claim 3, wherein the reinforcement assembly comprises an annular reinforcing rib and at least two bar-shaped reinforcing ribs, the annular reinforcing rib is arranged along edges of the bottom cover, the at least two bar-shaped reinforcing ribs are arranged within an enclosing range of the annular reinforcing rib; wherein two ends of each of the at least two bar-shaped reinforcing ribs are respectively connected to two opposite sides of the annular reinforcing rib; wherein the at least two bar-shaped reinforcing ribs are arranged in parallel with each other.

6. The pickup truck bed cover according to claim 5, the cover body comprises a first top surface part, a second top surface part, and a third top surface part, along the width direction of the cover body, the first top surface part, the second top surface part, and the third top surface part are distributed in sequence;
the second top surface part has a higher height than the first top surface part and the third top surface part on the front side of the cover body; the first top surface part and the third top surface part both protrude from the second top surface part on the back side of the cover body;
the annular reinforcing rib is arranged along the bottom edge of the cover body and surrounds the first top surface part, the second top surface part, and the third top surface part at the same time; the reinforcement assembly comprises two bar-shaped reinforcing ribs, and the two bar-shaped reinforcing ribs are arranged at the bottom of the second top surface part.

7. The pickup truck bed cover according to claim 6, wherein the reinforcement assembly comprises at least two transverse reinforcing ribs, the at least two transverse reinforcing ribs are arranged in parallel; the at least two transverse reinforcing ribs are arranged between the two bar-shaped reinforcing ribs, and two ends of each of the transverse reinforcing ribs are respectively connected to the two bar-shaped reinforcing ribs.

8. The pickup truck bed cover according to claim 7, wherein the reinforcement assembly comprises three transverse reinforcing ribs, the three transverse reinforcing ribs are sequentially and equally spaced, and the three transverse reinforcing ribs are perpendicularly set to the two bar-shaped reinforcing ribs.

9. The pickup truck bed cover according to claim 6, wherein the reinforcement assembly further comprises a plurality of V-shaped reinforcing ribs; wherein there are disposed at least two V-shaped reinforcing ribs between each of the at least two bar-shaped reinforcing ribs and a corresponding adjacent side wall of the annular reinforcing rib; wherein a bottom of each V-shaped reinforcing rib is connected to the corresponding bar-shaped reinforcing rib, and a top of the V-shaped reinforcing rib is connected to the corresponding adjacent side wall of the annular reinforcing rib.

10. The pickup truck bed cover according to claim 9, wherein the reinforcement assembly comprises four V-shaped reinforcing ribs, two of the four V-shaped reinforcing ribs are arranged in parallel between each of the bar-shaped reinforcing ribs and side-walls of the adjacent annular reinforcing rib.

11. The pickup truck bed cover according to claim 10, wherein the reinforcement assembly comprises a plurality of edge reinforcing ribs that are arranged between the annular reinforcing rib and the edges of the bottom cover, wherein one end of each of the plurality of edge reinforcing ribs is connected to an outer side of the annular reinforcing rib, and wherein another end of the edge reinforcing rib is connected to the corresponding edge of the bottom cover.

12. The pickup truck bed cover according to claim 3, wherein an interior of the reinforcement assembly is hollow, and the support assembly is filled inside the reinforcement assembly.

13. The pickup truck bed cover according to claim 1, wherein the pickup truck bed cover comprises a bracket assembly, the bracket assembly is arranged at the bottom of the cover body and is configured to connect the cover body to a vehicle body;
the cover body comprises a front end, a rear end, and two sides; wherein the rear end of the cover body is rotatably connected to the vehicle body, wherein the front end of the cover body is an opening and closing end of the pickup truck bed cover;
wherein the bracket assembly comprises two air springs and two connectors; wherein one of the two air springs and one of the two connectors are disposed at each of the two sides of the plate body; wherein each of the two connectors comprises a first fixing portion and a second fixing portion that are arranged in parallel, wherein the first fixing portion is arranged on a side of the second fixing portion facing away from the rear end of the cover body; wherein one end of each of the two air springs is connected to a portion of the cover body adjacent to the front end of the cover body, wherein another end of the air spring is connected to the first fixing portion, and wherein the second fixing portion is connected to the vehicle body.

14. The pickup truck bed cover according to claim 13, wherein the pickup truck bed cover comprises a switch assembly, the switch assembly comprising an elastic button piece, a first paddle, a second paddle, a first traction wire, a second traction wire, a first elastic lock piece, a second elastic lock piece, a first fixing plate, and a second fixing plate;
wherein the elastic button piece is connected to the front end of the plate body; wherein the first paddle, the second paddle, the first traction wire, the second traction wire, the first elastic lock piece, the second elastic lock piece, the first fixing plate, and the second fixing plate are arranged at the bottom of the cover body; wherein the first elastic lock piece and the second elastic lock piece are connected to the cover body; wherein the first fixing plate and the second fixing plate are connected to the vehicle body, wherein the first elastic lock piece and the second elastic lock piece are respectively disposed on both sides of the cover body, wherein the first fixing plate and the second fixing plate are respectively disposed on both sides of the cover body;
wherein the elastic button piece is inserted through the cover body, a control end of the elastic button piece protrudes from the front end of the cover body; wherein a connecting end of the elastic button piece is connected to both the first paddle and the second paddle; wherein the first paddle is further connected to one end of the first traction wire; wherein another end of the first traction wire is drivingly connected to the first elastic lock piece; wherein the first elastic lock piece is operative to be engaged and locked up with the first fixing plate; wherein the second paddle is further connected to one end of the second traction wire; wherein another end of the second traction wire is drivingly connected to the second elastic lock piece; wherein the second elastic lock piece is operative to be engaged and locked up with the second fixing plate;
wherein in response to the control end of the elastic button piece being pressed, the elastic button piece is operative to control the first traction wire and the second traction wire to contract through the first paddle and the second paddle, respectively, so that the first elastic lock piece is separated from the first fixing plate and the second elastic lock piece is separated from the second fixing plate, whereby the pickup truck bed cover is opened; wherein in response to the pickup truck bed cover being closed, the first elastic lock piece is interlocked with the first fixing plate, the second elastic lock piece is interlocked with the second fixing plate, the first traction wire and the second traction wire are extended, so that the first paddle, the second paddle and the elastic button piece are reset.

15. The pickup truck bed cover according to claim 14, wherein the first elastic lock piece comprises a first mounting seat, a second mounting seat, a first swing arm, a second swing arm, a first connecting column, a second connecting column, a first torsion spring, and a second torsion spring; wherein the first mounting seat is connected to the cover body, the second mounting seat and the first mounting seat are arranged to be aligned and combined with each other; a transmission space is formed between the second mounting seat and the first mounting seat, the first connecting column and the second connecting column are arranged in parallel in the transmission space; the two ends of the first connecting column are connected to the second mounting seat and the first mounting seat respectively; the two ends of the second connecting column are connected to the second mounting seat and the first mounting seat respectively;
the transmission end of the first swing arm, the second swing arm, the first torsion spring, and the second torsion spring are arranged in the transmission space; a main body of the first torsion spring is sleeved on the first connecting column, a torsion arm of the first torsion spring is connected to the first swing arm; a main body of the second torsion spring is sleeved on the second connecting column, a torsion arm of the second torsion spring is connected to the second swing arm; the first traction wire is connected to a connecting end of the first swing arm, a transmission end of the first swing arm is drivingly connected to one end of the second swing arm, the other end of the second swing arm comprises a lock hook; the first fixing plate comprises a fixing piece and a U-shaped lock rod, the fixing piece is connected to the vehicle body, both ends of the U-shaped lock rod are connected to the fixing piece;
when the first traction wire is retracted, the tightening force of the first traction wire is transmitted to the second swing arm through the first swing arm, the lock hook of the second swing arm is thus lifted, and the U-shaped lock rod is disengaged from the lock hook of the second swing arm; when the first traction wire is extended, the first swing arm is reset under the action of the first torsion spring, the second swing arm is reset under the action of the second torsion spring, and the lock hook of the second swing arm sinks.

16. The pickup truck bed cover according to claim 1, wherein further comprising a car wrap that wraps around an outer side of the cover body, the car wrap being made of a polypropylene material.

17. A pickup truck bed cover, comprising:
a cover body, the cover body is of an integral structure, and the cover body is of a carbon-fiber material structure;
a support assembly, the support assembly is of a PMI foam material structure and is arranged inside the cover body and configured to support the cover body; and
a reinforcement assembly, arranged at the bottom of the cover body and configured to increase a structural strength of the cover body, the reinforcement assembly and the cover body are of an integral structure, the reinforcement assembly comprises:
an annular reinforcing rib, arranged along edges of the bottom cover;
two bar-shaped reinforcing ribs, arranged within an enclosing range of the annular reinforcing rib; wherein two ends of each of the two bar-shaped reinforcing ribs are respectively connected to two opposite sides of the annular reinforcing rib; wherein the two bar-shaped reinforcing ribs are arranged in parallel with each other; and
three transverse reinforcing ribs, the three transverse reinforcing ribs are sequentially and equally spaced, the three transverse reinforcing ribs are arranged between the two bar-shaped reinforcing ribs, and the two ends of each of the three transverse reinforcing ribs are respectively connected to the two bar-shaped reinforcing ribs;
four V-shaped reinforcing ribs, two of the four V-shaped reinforcing ribs are arranged in parallel between each of the bar-shaped reinforcing rib and side-walls of the adjacent annular reinforcing rib; wherein a bottom of each V-shaped reinforcing rib is connected to the corresponding bar-shaped reinforcing rib, and a top of the V-shaped reinforcing rib is connected to the corresponding adjacent side wall of the annular reinforcing rib.

18. A method of manufacturing a pickup truck bed cover, comprising:
pasting carbon-fiber films with a first preset number of layers onto a mold;
placing a support assembly at a preset position on the carbon-fiber film with the first preset number of layers;
pasting carbon-fiber films with a second preset number of layers onto the support assembly; and
separating all the carbon-fiber films and the support assembly from the mold to obtain a pickup truck bed cover.
